(19) United States
(12) Patent Application Publication
(10) Pub. No.: US 2012/0091844 A1
(43) Pub. Date: Apr. 19, 2012

(54) ALLOY MATERIAL FOR R-T-B TYPE RARE EARTH PERMANENT MAGNET, METHOD FOR PRODUCING R-T-B TYPE RARE EARTH PERMANENT MAGNET, AND MOTOR

(75) Inventor: Kenichiro Nakajima, Chichibu-shi (JP)

(73) Assignee: SHOWA DENKO K.K., Minato-ku, Tokyo (JP)

(21) Appl. No.: 13/260,848

(22) PCT Filed: Jan. 18, 2010
(86) PCT No.: PCT/JP2010/000230

§ 371 Date: Nov. 29, 2011

(30) Foreign Application Priority Data
Mar. 31, 2009 (JP) 2009-084187
Jun. 16, 2009 (JP) 2009-143288
Aug. 12, 2009 (JP) 2009-187204

(51) Int. Cl. H02K 21/00; B22F 3/10; B22F 1/00

(52) U.S. Cl. 310/152; 75/255; 419/1

(57) ABSTRACT

An excellent R-T-B type rare earth permanent magnet having a high coercive force (Hcj), in which a decrease in magnetization (Br) is suppressed, is obtained by a method for producing an R-T-B type rare earth permanent magnet using, as a raw material, an R-T-B type rare earth magnet alloy material including an R-T-B type alloy (wherein R is one kind, or two or more kinds selected from Nd, Pr, Dy and Tb, 4% by mass to 10% by mass of Dy or Tb being essentially contained in the R-T-B type alloy, T is metal containing essentially Fe, and B is boron) and a metal powder.

### TECHNICAL FIELD

The present invention relates to an alloy material for an R-T-B type rare earth permanent magnet; a method for producing an R-T-B type rare earth permanent magnet; and a motor, and more particularly to an alloy material for an R-T-B type rare earth permanent magnet, which has excellent magnetic characteristics and enables the production of an R-T-B type rare earth permanent magnet suited for use in a motor; and a method for producing an R-T-B type rare earth permanent magnet, and a motor, which use the same.

Priority is claimed on Japanese Patent Application No. 2009-084187, filed Mar. 31, 2009, Japanese Patent Application No. 2009-143288, filed Jun. 16, 2009, and Japanese Patent Application No. 2009-187204, filed Aug. 12, 2009, the content of which is incorporated herein by reference.

### BACKGROUND ART

An R-T-B type magnet has hitherto been used in various motors and the like. A recent increase in demand for energy saving, in addition to an improvement in heat resistance of the R-T-B type magnet, has caused an increase in a usage rate in motors, including automobile motors.

The R-T-B type magnet contains Nd, Fe and B as main components. In an R-T-B type magnet alloy, R is that in which a portion of Nd is substituted with the other rare earth elements such as Pr, Dy and Tb. T is that in which a portion of Fe is substituted with other transition metals such as Co and Ni. B is boron and a portion thereof can be substituted with C or N.

There has been proposed, as a material used in an R—Fe—B type rare earth permanent magnet, an RFeB type magnet alloy wherein the volume percentage of an R₂Fe₁₄B phase (wherein R represents at least one kind of a rare earth element) as a main phase component is from 87.5 to 97.5% and the volume percentage of rare earths or rare earths and an oxide of a transition metal is from 0.1 to 3%, and wherein compounds selected from a ZrB compound composed of Zr and B as main components, a NbB compound composed of Nb and B as main components, and a HfB compound composed of Hf and B as main components are uniformly dispersed in a metal structure of the alloy, the compounds having an average grain diameter of 5 μm or less, and a maximum distance between compounds selected from the ZrB compound, the NbB compound and the HfB compound existing adjacent to each other in the alloy being 50 μm or less (see, for example, Patent Literature 1).

There has also been proposed, as a material used in an R—Fe—B type rare earth permanent magnet, an R—Fe—Co—B—Al—Cu (wherein R is one kind, or two or more kinds among Nd, Pr, Dy, Tb and Ho, 15 to 33% by mass of Nd being contained) type rare earth permanent magnet material wherein at least two kinds of an M-B type compound, an M-B—Cu type compound and an M-C type compound (M is one kind, or two or more kinds of Ti, Zr and Hf) and also an R oxide are precipitated in the alloy structure (see, for example, Patent Literature 2).

### CITATION LIST

### Patent Literature

[Patent Literature 1]
Japanese Patent No. 3,951,099
[Patent Literature 2]
Japanese Patent No. 3,891,307

### SUMMARY OF THE INVENTION

### Technical Problem

However, recently, an R-T-B type rare earth permanent magnet having a higher performance has been required, and also a further improvement in magnetic characteristics such as a coercive force of the R-T-B type rare earth permanent magnet has been required. Particularly in a motor, there is a problem such that a current is generated inside the motor during rotation and the motor per se reaches a high temperature as a result of heat generation, and thus a magnetic force decreases leading to a decrease in efficiency. In order to overcome this problem, a permanent magnet having a high coercive force at room temperature is required.

As a method of enhancing the coercive force of the R-T-B type rare earth permanent magnet, a method of increasing the Dy concentration in an R-T-B type alloy is considered. As the Dy concentration in the R-T-B type alloy is increased, a rare earth permanent magnet having a high coercive force (Hcj) can be obtained after sintering. However, when the Dy concentration in the R-T-B type alloy is increased, magnetization (Br) decreases.

Therefore, it was difficult to sufficiently enhance magnetic characteristics such as a coercive force of the R-T-B type rare earth permanent magnet in the prior art.

The present invention has been made in the light of the above circumstances, and an object thereof is to provide an alloy material for an R-T-B type rare earth permanent magnet, which enables a high coercive force (Hcj) without increasing the concentration of Dy in an R-T-B type alloy, and also can suppress a decrease in magnetization (Br) due to the addition of Dy and is used as a material of the R-T-B type rare earth permanent magnet, which enables excellent magnetic characteristics, and a method for producing an R-T-B type rare earth permanent magnet using the same.

Another object of the present invention is to provide a motor using an R-T-B type rare earth permanent magnet having excellent magnetic characteristics produced by the above method for producing an R-T-B type rare earth permanent magnet.

### Solution to Problem

The present inventors examined a relationship between the R-T-B type alloy and the magnetic characteristics of a rare earth permanent magnet obtained by using the same. As a result, the present inventors have found that, in the case an R-T-B type alloy containing Dy is sintered to produce a rare earth permanent magnet, a high coercive force (Hcj) Can be obtained without increasing the concentration of Dy in the R-T-B type alloy and also a decrease in magnetization (Br) due to the addition of Dy can be suppressed by mixing the R-T-B type alloy with a metal powder to prepare an alloy material for a permanent magnet, and forming and sintering the alloy to obtain an R-T-B type rare earth permanent magnet, thus leading to the present invention.

It is estimated that this effect is obtained by the following reason that, in case an alloy material for a permanent magnet, containing an R-T-B type alloy and a metal powder is prepared and the obtained alloy material is formed and sintered, metal contained in the metal powder penetrates into an R-rich phase constituting the R-T-B type alloy during sintering thereby increasing the concentration of the metal contained in the R-rich phase to obtain a high coercive force.

That is, the present invention provides the following respective inventions.

(1) An alloy material for an R-T-B type rare earth permanent magnet, including an R-T-B type alloy (wherein R is one kind, or two or more kinds selected from Nd, Pr, Dy and Tb, 4% by mass to 10% by mass of Dy or Tb being essentially contained in the R-T-B type alloy, T is metal containing essentially Fe, and B is boron), and a metal powder.
(2) The alloy material for an R-T-B type rare earth permanent magnet according to (1), wherein the metal powder contains any one of Al, Si, Ti, Ni, W, Zr, a TiAl alloy, Co and Fe.
(3) The alloy material for an R-T-B type rare earth permanent magnet according to (1) or (2), which contains 0.002% by mass to 1% by mass of the metal powder.
(4) The alloy material for an R-T-B type rare earth permanent magnet according to any one of (1) to (3), which is a mixture obtained by mixing a powder made of the R-T-B type alloy with the metal powder.
(5) A method for producing an R-T-B type rare earth permanent magnet, which includes forming and sintering the alloy material for an R-T-B type rare earth permanent magnet according to any one of (1) to (4).
(6) A motor including an R-T-B type rare earth permanent magnet produced by the method for producing an R-T-B type rare earth permanent magnet according to (5).

### Advantageous Effects of the Invention

Since the alloy material for an R-T-B type rare earth permanent magnet of the present invention contains an R-T-B type alloy (wherein R is one kind, or two or more kinds selected from Nd, Pr, Dy and Tb, 4% by mass to 10% by mass of Dy or Tb being essentially contained in the R-T-B type alloy, T is metal containing essentially Fe, and B is boron) and a metal powder, sufficiently high coercive force (Hcj) can be obtained without increasing the concentration of Dy in the R-T-B type alloy by forming and sintering the alloy material to prepare an R-T-B type rare earth permanent magnet, and also deterioration of magnetic characteristics such as magnetization (Br) due to the addition of Dy can be suppressed and an R-T-B type rare earth permanent magnet having excellent magnetic characteristics suited for use in a motor can be realized.

### DESCRIPTION OF THE EMBODIMENTS

Embodiments of the present invention will be described with reference to the accompanying drawings.

The alloy material for an R-T-B type rare earth permanent magnet of the present invention (hereinafter abbreviated to an “alloy material for a permanent magnet”) contains an R-T-B type alloy and a metal powder.

In the R-T-B type alloy constituting the alloy material for a permanent magnet of the present embodiment, R is one kind, or two or more kinds selected from Nd, Pr, Dy and Tb, 4% by mass to 10% by mass of Dy or Tb being essentially contained in the R-T-B type alloy, T is metal containing essentially Fe, and B is boron.

It is preferable that the R-T-B type alloy have the composition including 27 to 33% by mass, preferably 30 to 32% of R, 0.85 to 1.3% by mass, preferably 0.87 to 0.98% of B, and T including balance and inevitable impurities.

When the content of R constituting the R-T-B type alloy is less than 27% by mass, the coercive force may sometimes become insufficient. When the content of R is more than 33% by mass, the magnetization may become insufficient.

Examples of rare earth elements other than Dy contained in R of the R-T-B type alloy include Sc, Y, La, Ce, Pr, Nd, Pm, Sm, Eu, Gd, Tb, Ho, Er, Tm, Yb and Lu. Among these rare earth elements, Nd, Pr and Tb are used particularly preferably, and Nd is preferably used as a main component.

The amount of Dy contained in the R-T-B type alloy is 4% by mass to 10% by mass, preferably from 6% by mass to 9.5% by mass, and more preferably from 7% by mass to 9.5% by mass. When the amount of Dy contained in the R-T-B type alloy is more than 9.5% by mass, the magnetization (Br) remarkably decreases. When the amount of Dy contained in the R-T-B type alloy is less than 4% by mass, the coercive force of the rare earth permanent magnet produced using the same becomes insufficient for use in a motor.

T contained in the R-T-B type alloy is metal containing essentially Fe and can contain, in addition to Fe, other transition metals such as Co and Ni. It is preferable to contain, in addition to Fe, Co since the Curie temperature (Tc) can be improved.

The amount of B contained in the R-T-B type alloy is preferably from 0.85% by mass to 1.3% by mass. When the content of B constituting the R-T-B type alloy is less than 0.85% by mass, the coercive force may sometimes become insufficient. When the content of B is more than 1.3% by mass, the magnetization may remarkably decrease.

B contained in the R-T-B type alloy is boron, and a portion thereof can be substituted with C or N.

It is preferable that the R-T-B type alloy contain Al, Cu and Ga so as to enhance the coercive force.

It is more preferable that 0.03% by mass to 0.3% by mass of Ga be contained. It is preferable to contain 0.03% by mass or more of Ga since the coercive force can be effectively enhanced. However, it is not preferable that the content of Ga be more than 0.3% by mass since the magnetization decreases.

It is more preferable to contain 0.01% by mass to 0.5% by mass of Al. It is preferable to contain 0.01% by mass or more of Al since the coercive force can be effectively enhanced. However, it is not preferable that the content of Al be more than 0.5% by mass since the magnetization decreases.

Furthermore, the lower the oxygen concentration of the alloy material for a permanent magnet, the better. However, even when the content of oxygen is from 0.03% by mass to 0.5% by mass, and preferably from 0.05% by mass to 0.2% by mass, it is possible to achieve sufficient magnetic characteristics for use in a motor. In case the content of oxygen is more than 0.5% by mass, magnetic characteristics may remarkably deteriorate.

The lower the carbon concentration of the alloy material for a permanent magnet, the better. However, even when the content of carbon is from 0.003% by mass to 0.5% by mass, and preferably from 0.005% by mass to 0.2% by mass, it is possible to achieve sufficient magnetic characteristics for use in a motor. In case the content of carbon is more than 0.5% by mass, magnetic characteristics may remarkably deteriorate.

The alloy material for a permanent magnet is preferably a mixture obtained by mixing a powder made of an R-T-B type alloy with a metal powder.

An average grain diameter (d50) of the powder made of an R-T-B type alloy is preferably from 3 to 4.5 μm. The average grain diameter (d50) of the metal powder is preferably within a range from 0.01 to 300 μm.

It is possible to use, as the metal powder, Al, Si, Ti, Ni, W, Zr, a TiAl alloy, Cu, Mo, Co, Fe and the like, and there is no particularly limitation. The metal powder preferably includes any one of Al, Si, Ti, Ni, W, Zr, a TiAl alloy, Co and Fe, and more preferably Al or a TiAl alloy.

The content of the metal powder in the alloy material for a permanent magnet is preferably from 0.002% by mass to 2% by mass, more preferably from 0.002% by mass to 1% by mass, and still more preferably from 0.002% by mass to 0.5% by mass. When the content of the metal powder is less than 0.002% by mass, the effect of enhancing a coercive force (Hcj) may not be sufficiently obtained. It is not preferable that the content of the metal powder be more than 2% by mass since magnetic characteristics such as magnetization (Br) and maximum energy product (BHmax) remarkably deteriorate.

The alloy material for a permanent magnet of the present invention can be produced by mixing an R-T-B type alloy with a metal powder, but is preferably an alloy material produced by a method of mixing a powder made of an R-T-B type alloy with a metal powder.

The powder made of an R-T-B type alloy is obtained, for example, by a method in which a molten alloy is cast by a strip cast (SC) method to produce a cast alloy flake and the obtained cast alloy flake is crushed, for example, by a hydrogen decrepitation method and then pulverized by a pulverizer.

Examples of the hydrogen decrepitation method include a method in which a cast alloy flake is allowed to absorb hydrogen at room temperature and subjected to a heat treatment at about 300° C., and then dehydrogenation is carried out by reducing a pressure and a heat treatment is carried out at a temperature of about 500° C. to remove hydrogen in the cast alloy flake. Since the cast alloy flake in which hydrogen is absorbed undergoes volume expansion in the hydrogen decrepitation method, a lot of cracks easily arise inside the alloy, and thus the alloy is crushed.

Examples of the method of pulverizing the hydrogen-decrepitated cast alloy flake include a method in which a hydrogen-decrepitated cast alloy flake is finely pulverized into a powder having an average grain diameter of 3 to 4.5 μm by a pulverizer such as a jet mill using high-pressure nitrogen under 0.6 MPa.

Examples of the method of producing an R-T-B type rare earth permanent magnet using the thus obtained alloy material for a permanent magnet include a method in which 0.02% by mass to 0.03% by mass of zinc stearate, as a lubricant, is added to an alloy material for a permanent magnet and the alloy material is press-formed using a forming machine in a transverse magnetic field, followed by sintering in a vacuum at 1,030° C. to 1,080° C. and further heat treatment at 400° C. to 800° C. to obtain an R-T-B type rare earth permanent magnet.

While the case of producing an R-T-B type alloy using an SC method was described in the above example, the R-T-B type alloy used in the present invention is not limited to those produced using the SC method. For example, the R-T-B type alloy may be cast using a centrifugal casting method, a book mold method and the like.

As described above, the R-T-B type alloy and the metal powder may be mixed after pulverizing a cast alloy flake into a powder made of an R-T-B type alloy. For example, the cast alloy flake and the metal powder may be mixed before pulverizing the cast alloy flake to obtain an alloy material for a permanent magnet, followed by pulverization of the alloy material for a permanent magnet in which the cast alloy flake is contained. In this case, it is preferable to produce an R-T-B type rare earth permanent magnet by pulverizing an alloy material for a permanent magnet composed of a cast alloy flake and a metal powder in the same manner as in the method of pulverizing the cast alloy flake to obtain a powder, and then forming and sintering the powder in the same manner as described above.

Mixing of the R-T-B type alloy and the metal powder may be carried out after adding a lubricant such as zinc stearate to a powder made of an R-T-B type alloy.

The metal powder in the alloy material for a permanent magnet of the present invention may be fine and uniformly distributed, or may be neither fine nor uniformly distributed. For example, the grain size may be 1 μm or more, or the effect is exerted even when a metal powder aggregate in size of 5 μm or more is formed. The higher the Dy concentration, the higher the effect of improving the coercive force by the present invention. When Ga is contained, the larger effect is exerted.

The R-T-B type rare earth permanent magnet obtained by forming and sintering the alloy material for a permanent magnet of the present embodiment has a high coercive force (Hcj), and is also suited for use as a magnet for a motor, which has sufficiently high magnetization (Br).

The higher the coercive force (Hcj) of the R-T-B type rare earth permanent magnet, the better. In the case of using as a magnet for a motor, the coercive force is preferably 30 kOe or more. When the coercive force (Hcj) is less than 30 kOe in the magnet for a motor, the magnet may sometimes lack in heat resistance as the motor.

The higher the magnetization (Br) of the R-T-B type rare earth permanent magnet, the better. In the case of using as a magnet for a motor, the magnetization is preferably 10.5 kG or more. When the magnetization (Br) of the R-T-B type rare earth permanent magnet is less than 10.5 kG, the efficiency of the motor is down, and thus the magnet is not preferable for use in a motor.

Since the alloy material for a permanent magnet of the present embodiment contains an R-T-B type alloy (wherein R is one kind, or two or more kinds selected from Nd, Pr, Dy and Tb, 4% by mass to 10% by mass of Dy or Tb being essentially contained in the R-T-B type alloy, T is metal containing essentially Fe, and B is boron) and a metal powder, sufficiently high coercive force (Hcj) can be obtained without increasing the concentration of Dy in the R-T-B type alloy by forming and sintering the alloy material to produce an R-T-B type rare earth permanent magnet, and also deterioration of magnetic characteristics such as magnetization (Br) due to the addition of Dy can be suppressed and an R-T-B type rare earth permanent magnet having excellent magnetic characteristics suited for use in a motor can be realized.

In the case the alloy material for a permanent magnet of the present embodiment is a mixture obtained by mixing a powder made of an R-T-B type alloy with a metal powder, a uniform quality alloy material for a permanent magnet can be easily obtained only by mixing a powdered R-T-B type alloy with a metal powder, and also a uniform-quality R-T-B type rare earth permanent magnet can be easily obtained by forming and sintering the alloy material.

Since the method for producing an R-T-B type rare earth permanent magnet of the present embodiment is a method of producing an R-T-B type rare earth permanent magnet by forming and sintering the alloy material for a permanent magnet of the present embodiment, an R-T-B type rare earth permanent magnet having excellent magnetic characteristics suited for use in a motor can be obtained.

### EXAMPLES

### Test Example 1

Nd metal (having a purity of 99% by weight or more), Pr metal (having a purity of 99% by weight or more), Dy metal (having a purity of 99% by weight or more), ferroboron (containing 80% of Fe and 20% by weight of B), Al metal (having a purity of 99% by weight or more), Co metal (having a purity of 99% by weight or more), Cu metal (having a purity of 99% by weight or more), Ga metal (having a purity of 99% by weight or more) and bloom iron (having a purity of 99% by weight or more) were weighed so as to satisfy the compositions of an alloy A to an alloy F shown in Table 1, and then charged in an alumina crucible.

Thereafter, the atmosphere inside a high-frequency vacuum induction furnace accommodating the alumina crucible was substituted with Ar and, after melting by heating to 1,450° C., the molten alloy was poured into a water-cooled copper roll and then cast by a strip cast (SC) method under the conditions of a roll peripheral velocity of 1.0 m/second, an average thickness of about 0.3 mm, a distance between R-rich phases of 3 to 15 μm, and a volume ratio other than an R-rich phase (main phase)≧(138−1.6r) (wherein r is the content of rare earths (Nd, Pr, Dy)) to obtain a cast alloy flake.

TABLE 1

| | Thickness | Components (% by weight) | | | | | | | | | | | Average grain |
|---|---|---|---|---|---|---|---|---|---|---|---|---|---|
| | (mm) | Nd | Pr | Dy | B | Al | Co | Cu | Ga | C | O | Fe | size d50 (μm) |
| Alloy A | 0.29 | 17.0 | 6.0 | 9.5 | 0.90 | 0.1 | 1.0 | 0.1 | 0.08 | 0.012 | 0.013 | Balance | 4.5 |
| Alloy B | 0.30 | 20.0 | 6.0 | 4.5 | 0.90 | 0.1 | 1.0 | 0.1 | 0.08 | 0.012 | 0.013 | Balance | 4.5 |
| Alloy C | 0.30 | 18.4 | 6.0 | 7.5 | 0.90 | 0.1 | 1.0 | 0.1 | 0.08 | 0.012 | 0.013 | Balance | 4.5 |
| Alloy D | 0.30 | 18.0 | 6.0 | 6.9 | 0.90 | 0.1 | 1.0 | 0.1 | 0.08 | 0.012 | 0.013 | Balance | 4.5 |
| Alloy E | 0.30 | 19.0 | 6.0 | 7.5 | 0.90 | 0.2 | 1.0 | 0.1 | 0.00 | 0.012 | 0.013 | Balance | 4.5 |
| Alloy F | 0.30 | 17.3 | 6.0 | 8.8 | 1.00 | 0.2 | 1.0 | 0.1 | 0.00 | 0.012 | 0.013 | Balance | 4.5 |
| Alloy G | 0.30 | 24.5 | 6.0 | 0.0 | 0.90 | 0.1 | 1.0 | 0.1 | 0.08 | 0.012 | 0.013 | Balance | 4.5 |

The distance between R-rich phases and the volume ratio of the main phase of the cast alloy flake thus obtained were examined by the following methods. That is, the cast alloy flake having a thickness within an average thickness ±10% was embedded in a resin and, after polishing, a backscattered electron image was photographed by a scanning electron microscope (JEOL JSM-5310). Using the obtained 300 times magnification micrograph, the distance between R-rich phases was measured and also the volume ratio of the main phase was calculated. As a result, the distance between R-rich phases of alloys A to F shown in Table 1 was from 4 to 5 μm, and the volume ratio of the main phase was from 90 to 95%.

Next, the cast alloy flake was crushed by the following hydrogen decrepitation method. First, the cast alloy flake was coarsely pulverized so as to adjust the diameter to about 5 mm, which was allowed to absorb hydrogen by inserting into hydrogen at room temperature. Subsequently, the cast alloy flake, which was coarsely pulverized and allowed to absorb hydrogen, was subjected to a heat treatment of heating to 300° C. Thereafter, the cast alloy flake was crushed by a method in which dehydrogenation is carried out by reducing a pressure and a heat treatment of heating to 500° C. is carried out to remove hydrogen in the cast alloy flake, followed by cooling to room temperature.

Next, 0.025% by weight of zinc stearate as a lubricant was added to the hydrogen-decrepitated cast alloy flake and the hydrogen-decrepitated cast alloy flake was finely pulverized into a powder having an average grain diameter of 4.5 μm by a jet mill (HOSOKAWA MICRON 100AFG) using high-pressure nitrogen under 0.6 MPa.

An alloy material for a permanent magnet was produced by adding a metal powder having a grain size shown in Table 2 to the thus obtained powder made of an R-T-B type alloy having an average grain diameter shown in Table 1 (alloys A to F) in a proportion shown in Table 3 or Table 4 (concentration (% by mass) of a metal powder contained in the alloy material for a permanent magnet), followed by mixing. The grain size of the metal powder was measured by a laser diffractometer.

TABLE 2

| Metal powder | Average grain size d50 (μm) |
|---|---|
| Al | 47.6 |
| Co | 5.1 |
| Cu | 24.9 |
| Fe | 6.2 |
| Mo | 13.1 |
| Ni | 46.8 |
| Si | 20.0 |
| Ta | 11.5 |
| Ti | 24.5 |
| Ti—Al | 170.4 |
| W | 6.5 |
| Zr | 30.8 |

TABLE 3

| | | Additive | Hcj | Br | SR | BHmax |
|---|---|---|---|---|---|---|
| | Metal powder | amount | (kOe) | (kG) | (%) | (MGOe) |
| Alloy A | None | None | 29.84 | 11.65 | 90.83 | 33.17 |
| | Al | 0.20% | 33.97 | 11.53 | 92.73 | 32.77 |
| | Co | 1.00% | 32.33 | 11.79 | 91.33 | 34.07 |
| | Fe | 0.20% | 30.62 | 11.50 | 89.07 | 32.18 |
| | | 1.00% | 34.07 | 11.62 | 90.87 | 32.99 |
| | | 2.00% | 34.08 | 11.74 | 90.70 | 33.77 |
| | | 3.00% | 32.49 | 11.46 | 88.71 | 31.73 |
| | | 4.00% | 33.53 | 11.81 | 88.86 | 34.23 |
| | Si | 0.20% | 33.68 | 11.34 | 89.74 | 31.70 |
| | Ta | 1.00% | 34.02 | 11.52 | 90.67 | 32.67 |
| | | 2.00% | 33.79 | 11.30 | 89.22 | 31.98 |
| | | 3.00% | 33.89 | 11.11 | 89.51 | 31.00 |
| | | 4.00% | 32.48 | 10.70 | 85.69 | 26.72 |
| | | 5.00% | 33.04 | 10.28 | 79.66 | 22.36 |
| | | 6.00% | 34.25 | 9.75 | 73.84 | 18.41 |
| | Ti | 0.20% | 33.25 | 11.62 | 92.67 | 33.26 |
| | Ti—Al | 0.01% | 30.64 | 11.29 | 87.74 | 31.26 |
| | | 0.02% | 33.79 | 11.36 | 87.74 | 31.52 |
| | | 0.05% | 33.06 | 11.18 | 86.21 | 30.42 |
| | | 0.20% | 35.57 | 11.05 | 86.03 | 29.56 |
| | W | 0.20% | 30.03 | 11.38 | 89.14 | 31.54 |
| | | 1.00% | 35.41 | 11.38 | 89.92 | 31.92 |
| | | 3.00% | 33.22 | 11.15 | 87.24 | 31.18 |
| | | 4.00% | 32.65 | 10.89 | 84.35 | 29.42 |
| | Zr | 0.20% | 33.98 | 11.50 | 91.34 | 32.52 |
| Alloy B | None | None | 22.94 | 12.81 | 94.39 | 39.67 |
| Alloy C | None | None | 27.10 | 12.27 | 92.54 | 36.76 |
| | Al | 0.10% | 28.74 | 12.09 | 92.09 | 35.67 |
| | | 0.20% | 29.85 | 12.05 | 92.91 | 35.43 |
| | C | 0.10% | 27.67 | 12.06 | 91.32 | 35.43 |
| | Cu | 0.10% | 27.90 | 12.16 | 90.21 | 35.95 |
| | Mo | 0.10% | 27.48 | 12.19 | 90.65 | 35.98 |
| | Ni | 0.10% | 28.08 | 12.19 | 91.67 | 36.16 |
| | Si | 0.10% | 28.33 | 12.18 | 92.23 | 36.16 |
| | Ti | 0.10% | 29.49 | 12.16 | 90.76 | 36.00 |
| | | 0.20% | 29.15 | 12.25 | 92.02 | 36.45 |
| | Ti—Al | 0.10% | 30.13 | 11.84 | 91.24 | 34.36 |
| | W | 0.10% | 27.13 | 12.29 | 91.55 | 36.76 |
| | Zr | 0.10% | 29.62 | 12.08 | 91.71 | 35.61 |

TABLE 4

| | | Additive | Hcj | Br | SR | BHmax |
|---|---|---|---|---|---|---|
| | Metal powder | amount | (kOe) | (kG) | (%) | (MGOe) |
| Alloy D | None | None | 28.23 | 12.02 | 89.68 | 34.08 |
| | Al | 0.10% | 30.77 | 11.95 | 91.31 | 34.94 |
| | | 0.20% | 30.93 | 11.93 | 92.00 | 34.81 |
| | Mo | 0.10% | 28.31 | 11.84 | 89.19 | 34.09 |
| | Ni | 0.10% | 28.97 | 11.88 | 89.32 | 34.37 |
| | Si | 0.10% | 28.79 | 11.95 | 90.17 | 34.89 |
| | Ti | 0.10% | 30.75 | 11.93 | 90.21 | 34.76 |
| | | 0.20% | 30.43 | 11.99 | 90.31 | 35.13 |
| | Ti—Al | 0.10% | 31.51 | 11.70 | 90.72 | 33.56 |
| | W | 0.10% | 28.87 | 11.92 | 90.40 | 34.67 |
| | Zr | 0.10% | 30.15 | 12.02 | 91.19 | 35.20 |
| Alloy E | None | | 27.20 | 11.71 | 93.07 | 33.47 |
| | Al | 0.10% | 29.23 | 11.62 | 93.95 | 32.97 |
| | | 0.20% | 30.28 | 11.57 | 93.08 | 32.73 |
| | Ni | 0.05% | 27.91 | 11.73 | 92.33 | 33.62 |
| | | 0.10% | 27.51 | 11.71 | 93.20 | 33.59 |
| | | 0.20% | 28.71 | 11.62 | 93.33 | 33.06 |
| | | 0.40% | 28.31 | 11.67 | 93.48 | 33.37 |
| | Si | 0.10% | 28.07 | 11.73 | 93.16 | 33.69 |
| | Ti | 0.10% | 27.38 | 11.73 | 90.84 | 33.61 |
| | | 0.20% | 28.11 | 11.65 | 92.45 | 33.19 |
| | Ti—Al | 0.10% | 28.21 | 11.44 | 92.49 | 32.14 |
| | W | 0.10% | 28.01 | 11.57 | 90.59 | 32.78 |
| | Zr | 0.10% | 27.43 | 11.81 | 92.64 | 34.09 |
| Alloy F | None | | 29.91 | 11.55 | 93.64 | 32.63 |
| | Al | 0.10% | 32.13 | 11.45 | 93.48 | 32.37 |
| | C | 0.10% | 30.96 | 11.32 | 90.87 | 31.37 |
| | Si | 0.10% | 32.21 | 11.26 | 89.02 | 31.13 |
| | Ti | 0.10% | 30.56 | 11.42 | 92.73 | 32.07 |
| Alloy G | None | 2.00% | 15.26 | 13.93 | 95.05 | 46.40 |
| | Fe | 2.00% | 14.22 | 13.83 | 95.14 | 45.89 |
| | Ta | 2.00% | 13.62 | 13.49 | 91.48 | 42.52 |
| | w | 2.00% | 13.99 | 13.26 | 91.95 | 41.25 |

Hcj: Coercive force
Br: Magnetization
SR: Squareness
BHmax: Maximum energy product

Next, the thus obtained alloy material for a permanent magnet was press-formed under a forming press 0.8 t/cm² using a forming machine in a transverse magnetic field to obtain a powder compact. Thereafter, the obtained powder compact was sintered in a vacuum. The sintering temperature varies depending on the alloy, and the alloy A was sintered at 1,080° C., the alloys B, C and D were sintered at 1,060° C., the alloys E and F were sintered at 1,040° C., and the alloy G was sintered at 1,030° C. Thereafter, the sintered alloy compacts were subjected to a heat treatment at 500° C. and cooled to obtain R-T-B type rare earth permanent magnets.

Then, magnetic characteristics of each of R-T-B type rare earth permanent magnets obtained by using an alloy material for a permanent magnet, containing a metal powder, or an alloy material for a permanent magnet, containing no metal powder were measured by BH Curve Tracer (TOEI INDUSTRY CO., LTD. TPM2-10). The results are shown in Table 3 and Table 4.

In Table 3 and Table 4, “Hcj” refers to a coercive force, “Br” refers to magnetization, “SR” refers to squareness, and “BHmax” refers to a maximum energy product. The value of these magnetic characteristics is an average of measured values of five R-T-B type rare earth permanent magnets.

As shown in Table 3 and Table 4, in the R-T-B type rare earth permanent magnets obtained by using alloy materials for a permanent magnet, containing R-T-B type alloys of the alloy A and the alloys C to F, and a metal powder, the coercive force (Hcj)) increased as compared with the R-T-B type rare earth permanent magnet obtained by using alloy material for a permanent magnets, containing the alloy A and the alloys C to F, and containing no metal powder. As is apparent from these results, it is possible to increase the coercive force without increasing the additive amount of Dy by using the alloy material for a permanent magnet containing a metal powder.

As shown in Table 3, when the alloy A containing no metal powder is compared with the alloy C, the coercive force (Hcj)) increased in an alloy A having a high Dy concentration as compared with the alloy C, but magnetization (Br) and maximum energy product (BHmax) decrease. To the contrary, in those containing the alloy C and the metal powder, for example, in the alloy C to which 0.2% of Al is added, the coercive force (Hcj)) equivalent to the alloy A containing no metal powder is obtained without increasing the Dy concentration, and also the magnetization (Br) and maximum energy product (BHmax) increase as compared with the alloy A containing no metal powder.

In the alloy G containing no Dy, in the case of containing a metal powder, all magnet characteristics including the coercive force (Hcj) deteriorate. As is apparent from these results, Dy is essential so as to obtain the effect of the present invention.

### INDUSTRIAL APPLICABILITY

A method for producing an R-T-B type rare earth permanent magnet has been developed using an alloy material for an R-T-B type rare earth permanent magnet, which has excellent magnetic characteristics, and the R-T-B type rare earth permanent magnet having a high coercive force and excellent magnetic characteristics obtained by the method is widely used in a motor.

1. An alloy material for an R-T-B type rare earth permanent magnet, comprising:
an R-T-B type alloy (wherein R is one kind, or two or more kinds selected from Nd, Pr, Dy and Tb, 4% by mass to 10% by mass of Dy or Tb being essentially contained in the R-T-B type alloy, T is metal containing essentially Fe, and B is boron), and
a metal powder.

2. The alloy material for an R-T-B type rare earth permanent magnet according to claim 1, wherein the metal powder contains any one of Al, Si, Ti, Ni, W, Zr, a TiAl alloy, Co, Fe and Ta.

3. The alloy material for an R-T-B type rare earth permanent magnet according to claim 1, which contains 0.002% by mass to 6% by mass of the metal powder.

4. The alloy material for an R-T-B type rare earth permanent magnet according to claim 1, which is a mixture obtained by mixing a powder made of the R-T-B type alloy with the metal powder.

5. A method for producing an R-T-B type rare earth permanent magnet, which comprises forming and sintering the alloy material for an R-T-B type rare earth permanent magnet according to claim 1.

6. A motor comprising an R-T-B type rare earth permanent magnet produced by the method for producing an R-T-B type rare earth permanent magnet according to claim 5.
